(19) United States
(12) Patent Application Publication
(10) Pub. No.: US 2026/0245270 A1
(43) Pub. Date: Aug. 20, 2026

(54) VISUALIZATION DEVICE, VISUALIZATION METHOD, AND STORAGE MEDIUM

(71) Applicant: NEC Corporation, Tokyo (JP)

(72) Inventors: Satoshi MATSUI, Tokyo (JP); Eiji KUNIHARA, Tokyo (JP); Tomomi MAEHATA, Tokyo (JP); Takashi NANJI, Tokyo (JP); Junichi KURIMOTO, Tokyo (JP); Yoshikazu WATANABE, Tokyo (JP); Kazuo ENDO, Tokyo (JP); Yasushi YAGYU, Tokyo (JP); Takeshi WATANABE, Tokyo (JP); Taiga WAKABAYASHI, Tokyo (JP); Junya OKABE, Tokyo (JP)

(73) Assignee: NEC Corporation, Tokyo (JP)

(21) Appl. No.: 19/161,418

(22) PCT Filed: Mar. 13, 2023
(86) PCT No.: PCT/JP2023/009525

§ 371 Date: Sep. 2, 2025

(51) Int. Cl. G06T 11/26; G06Q 10/087; G06T 11/60

(52) U.S. Cl. CPC G06T 11/26; G06Q 10/087; G06T 11/60

(57) ABSTRACT

A visualization device includes: a profit calculation unit that calculates a profit amount from a dataset and a shipment value of products, the dataset being a transition dataset including a stock cost and a cost price of the products produced per a unit period, the profit amount representing profit obtained by subtracting the cost prices and the stock costs from product sales; an index value calculation unit that calculate the values of two different indices; a screen generation unit that generates a screen with a graphic at a position specified by the values of the two indices in an area with one index assigned to a vertical axis and the other to a horizontal axis, the size of the graphic corresponding to the profit amount; and an output unit that outputs the screen.

### TECHNICAL FIELD

The present disclosure relates to a technique for visualizing, and more particularly, to a technique for visualizing numerical values relating to performance of a company or the like.

### BACKGROUND ART

In order to make a decision on management of a company or the like, it is required to visualize numerical values relating to performance.

PTL 1 discloses a demand-supply adjustment simulation method for calculating a loss cost by multiplying any one of an inventory quantity and a shortage quantity at a planned time by a loss cost per unit quantity for each demand fluctuation scenario. The demand-supply adjustment simulation method of PTL 1 displays the loss cost for each demand fluctuation scenario in parallel in such a way that the user can determine an arrival quantity at the planned time.

### CITATION LIST

### Patent Literature

PTL 1: JP 2001-266048 A

### SUMMARY OF INVENTION

### Technical Problem

In the technique of PTL 1, it is not possible to visualize a value of an index that does not affect a financial index other than an inventory at the beginning of a term and the inventory at the end of the term and that takes into account the influence of cost due to the inventory between the beginning of the term and the end of the term.

One object of the present disclosure is to provide a visualization device or the like capable of visualizing a value of an index in consideration of an influence of cost due to inventory between the beginning of a term and the end of the term.

### Solution to Problem

A visualization device according to one aspect of the present disclosure includes effective profit amount calculation means for calculating an effective profit amount representing an amount of profit obtained by subtracting a sum of cost prices and a sum of inventory costs from sales of products in a predetermined length period from a target data set that is a transition data set including data indicating transition of the inventory cost due to the inventory of the products and the cost prices of the produced products for each unit period shorter than a period of a predetermined length period in the period and a shipping amount of products, index value calculation means for calculating, by using at least one of the target data set, the shipping amount, and a transition of the inventory quantity of products for each unit period in the period, values of two different indexes related to the transition of the inventory quantity in the period, screen generation means for generating a screen on which a graphic having a size associated to the effective profit amount is superimposed at a position specified by values of the two indexes in an area in which one of the two indexes is a vertical axis and the other is a horizontal axis, and output means for outputting the screen.

A visualization method according to another aspect of the present disclosure includes calculating an effective profit amount representing an amount of profit obtained by subtracting a sum of cost prices and a sum of inventory costs from sales of products in a predetermined length period from a target data set that is a transition data set including data indicating transition of the inventory cost due to the inventory of the products and the cost prices of the produced products for each unit period shorter than a period of a predetermined length in the period and a shipping amount of products, calculating, by using at least one of the target data set, the shipping amount, and a transition of the inventory quantity of products for each unit period in the period, values of two different indexes related to the transition of the inventory quantity in the period, generating a screen on which a graphic having a size associated to the effective profit amount is superimposed at a position specified by values of the two indexes in an area in which one of the two indexes is a vertical axis and the other is a horizontal axis, and outputting the screen.

A program according to still another aspect of the present disclosure, causes a computer to execute effective profit amount calculation processing for calculating an effective profit amount representing an amount of profit obtained by subtracting a sum of cost prices and a sum of inventory costs from sales of products in a predetermined length period from a target data set that is a transition data set including data indicating transition of the inventory cost due to the inventory of the products and the cost prices of the produced products for each unit period shorter than a period of a predetermined length in the period and a shipping amount of products, index value calculation processing for calculating, by using at least one of the target data set, the shipping amount, and a transition of the inventory quantity of products for each unit period in the period, values of two different indexes related to the transition of the inventory quantity in the period, screen generation processing for generating a screen on which a graphic having a size associated to the effective profit amount is superimposed at a position specified by values of the two indexes in an area in which one of the two indexes is a vertical axis and the other is a horizontal axis, and output processing for outputting the screen.

### Advantageous Effects of Invention

The present disclosure has an effect of visualizing the value of the index in which the influence of cost due to the transition of the inventory between the beginning of the term and the end of the term is taken into consideration.

### BRIEF DESCRIPTION OF DRAWINGS

FIG. 1 is a block diagram illustrating an example of a configuration of a visualization device according to a first example embodiment of the present disclosure.

FIG. 2 is a flowchart illustrating an example of an operation of the visualization device according to the first example embodiment of the present disclosure.

FIG. 3 is a diagram schematically illustrating an example of a screen output by the visualization device according to the first example embodiment of the present disclosure.

FIG. 4 is a flowchart illustrating an example of operation of a visualization device according to a first modification of the first example embodiment of the present disclosure.

FIG. 5 is a diagram schematically illustrating an example of a screen output by a visualization device according to the first modification of the first example embodiment of the present disclosure.

FIG. 6 is a block diagram illustrating an example of a configuration of a visualization device according to a second example embodiment of the present disclosure.

FIG. 7 is a flowchart illustrating an example of an operation of a visualization device according to the second example embodiment of the present disclosure.

FIG. 8 is a flowchart illustrating an example of an operation of a visualization device according to the second example embodiment of the present disclosure.

FIG. 9 is a diagram schematically illustrating an example of a screen output by the visualization device according to the second example embodiment of the present disclosure.

FIG. 10 is a flowchart illustrating an example of operation of a visualization device according to a first modification of the second example embodiment of the present disclosure.

FIG. 11 is a diagram schematically illustrating an example of a screen output by the visualization device according to the first modification of the second example embodiment of the present disclosure.

FIG. 12 is a block diagram illustrating an example of a configuration of a visualization device according to a second modification of the second example embodiment of the present disclosure.

FIG. 13 is a flowchart illustrating an example of operation of the visualization device according to the second modification of the second example embodiment of the present disclosure.

FIG. 14 is a block diagram illustrating an example of a configuration of a visualization device according to a third modification of the second example embodiment of the present disclosure.

FIG. 15 is a flowchart illustrating an example of operation of the visualization device according to the third modification of the second example embodiment of the present disclosure.

FIG. 16 is a flowchart illustrating an example of operation of generation processing of the visualization device according to the third modification of the second example embodiment of the present disclosure.

FIG. 17 is a diagram illustrating an example of a hardware configuration of a computer that can implement the visualization device according to any one of the example embodiments and the modifications of the present disclosure.

### EXAMPLE EMBODIMENT

Hereinafter, example embodiments of the present disclosure will be described in detail using the drawings.

### First Example Embodiment

First, a first example embodiment of the present disclosure will be described in detail with reference to the drawings.

### Configuration

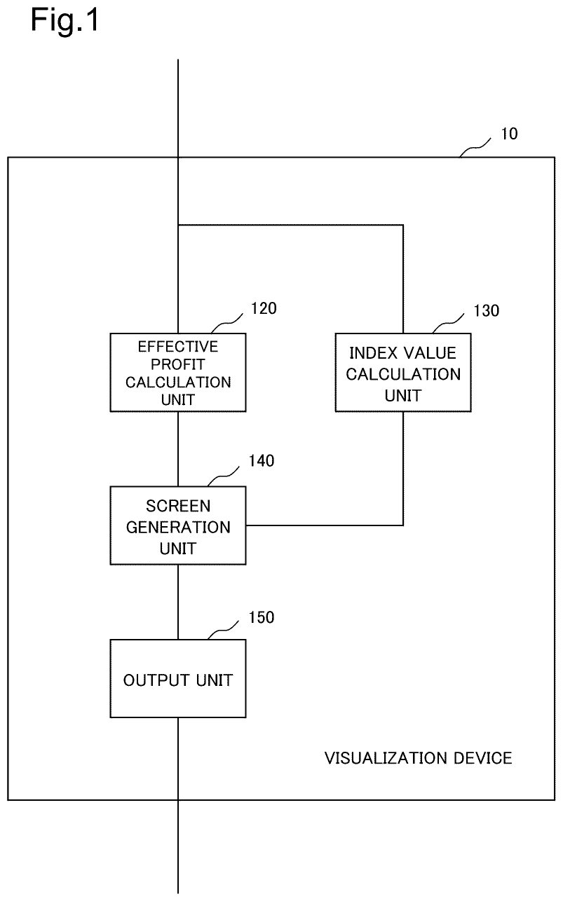

FIG. 1 is a block diagram illustrating an example of a configuration of a visualization device according to a first example embodiment of the present disclosure. In the example illustrated in FIG. 1, a visualization device 10 according to the first example embodiment of the present disclosure includes an effective profit calculation unit 120, an index value calculation unit 130, a screen generation unit 140, and an output unit 150.

### Effective Profit Calculation Unit 120

The effective profit calculation unit 120 calculates an effective profit amount representing the amount of profit obtained by subtracting the sum of the cost price and the sum of the inventory cost from the sales of a product in a period of a predetermined length from a target data set and a shipping amount of products. A transition data set is data including data representing a transition between an inventory cost due to an inventory of products and a cost price of a produced product for each unit period shorter than a period of a predetermined length in the period. In the following description, the transition data set of the present example embodiment is also referred to as a target data set. In other words, the target data set of the present example embodiment is a transition data set. The shipment of products is, for example, the total amount of sales due to the shipment of the products in the above-mentioned predetermined period. The shipping amount of products may be given to the effective profit calculation unit 120 in advance. The shipping amount of products may be included in the target data set.

The period of the predetermined length is, for example, a period of one year, half a year, three months, one month, or the like. The unit period is, for example, a predetermined period shorter than the period having the above-described predetermined length, such as one day, five days, or one week.

### Index Value Calculation Unit 130

The index value calculation unit 130 uses at least one of at least a part of the target data set, the shipping amount (that is, the shipping amount of products) described above, and the transition of the inventory quantity of products for each unit period described above in the period described above to calculate values of two different indexes related to the transition of the inventory in the period. The two indexes are, for example, an inventory turnover rate and an effective profit rate. The two indexes are not limited to these examples. Other examples of the two indexes will be described in detail later.

The effective profit rate is, for example, a value obtained by dividing the effective profit amount by the sales amount. The index value calculation unit 130 calculates a value obtained by dividing the effective profit amount in the period of the predetermined length by the sales amount of products in the period of the predetermined length as the effective profit rate. The sales amount of products is the shipping amount of products described above.

For example, the index value calculation unit 130 calculates, as the value of the inventory turnover rate, a value obtained by dividing the shipment quantity in the period of the predetermined length by a cumulative value of the inventory quantity of products for each unit period in the period.

The index value calculation unit 130 may be given in advance the shipment quantity of products in the period of the predetermined length. For example, in a case where the product is one type of products and the price of one product does not change, the index value calculation unit 130 holds the price of one product in advance. In this case, the index value calculation unit 130 calculates a value obtained by dividing the shipping amount of products by the price of one product as the shipment quantity of products. The target data set further including the transition of the shipment quantity of products for each unit period in the period of the predetermined length may be given to the index value calculation unit 130. In this case, the index value calculation unit 130 calculates the total number of shipment quantity in the period of the predetermined length from the transition of the shipment quantity of products in each unit period in the period of the predetermined length. The index value calculation unit 130 further calculates a cumulative value of the inventory quantity for each unit period in a period of a predetermined length from the transition of the inventory quantity included in the target data set.

Then, the index value calculation unit 130 calculates a value obtained by dividing the shipment quantity of products in the period of the predetermined length obtained in this manner by the cumulative value of the inventory quantity of products for each unit period in the period as a value of the inventory turnover rate.

### Screen Generation Unit 140

The screen generation unit 140 generates a screen on which a graphic having a size associated to the effective profit amount is superimposed at a position specified by the values of the two indexes in an area where one of the two indexes is the vertical axis and the other is the horizontal axis. In the examples of the two indexes described above, for example, the horizontal axis represents the inventory turnover rate, and the vertical axis represents the effective profit rate. The horizontal axis may be the effective profit rate, and the vertical axis may be the inventory turnover rate.

The graphic having a size associated to the effective profit amount is, for example, a graphic having a larger size as the effective profit amount is larger. In a case where the effective profit amount is negative, the screen generation unit 140 may generate a screen on which a graphic having a larger size is superimposed as the absolute value of the effective profit amount is larger. The form of the graphic representing the effective profit amount with a negative value superimposed by the screen generation unit 140 may be different from the form of the graphic representing the effective profit amount with a positive value. In this case, the form of the graphic is, for example, at least one of the shape of the graphic, the color of the graphic, the thickness of the contour line of the graphic, the color of the contour line of the graphic, the form of the contour line of the graphic (for example, a solid line, a broken line, a one-dot chain line, and the like), and the like. Each of the two indexes is associated with a different one of the two axes of the two-dimensional coordinate system set on the screen. In other words, a set of values of the two indexes is associated with coordinates in a two-dimensional coordinate system set on the screen. The positions specified by the values of the two indexes are positions represented by coordinates associated with the values of the two indexes in a two-dimensional coordinate system associated with the two indexes. The screen generation unit 140 generates a screen on which the graphic is superimposed in such a way that a position specified by the values of the two indexes matches a position of a representative point of the graphic. The representative point of the graphic is a predetermined point (for example, a center of gravity or a predefined center point, etc.). The representative point of the graphic is not limited to these examples, and may be, for example, a vertex or an end point. The graphic is, for example, any of a circle, a triangle, a quadrilateral, another polygon, an arrow, and the like.

Superimposing a graphic or the like on a certain position of the screen means replacing an area overlapping the graphic or the like with the graphic or the like in a case where the graphic or the like is arranged at the position of the screen. Instead of generating a screen and superimposing a graphic on the generated screen, the screen generation unit 140 may generate a screen in a state where the graphic is superimposed.

### Output Unit 150

The output unit 150 outputs a screen.

### Operation

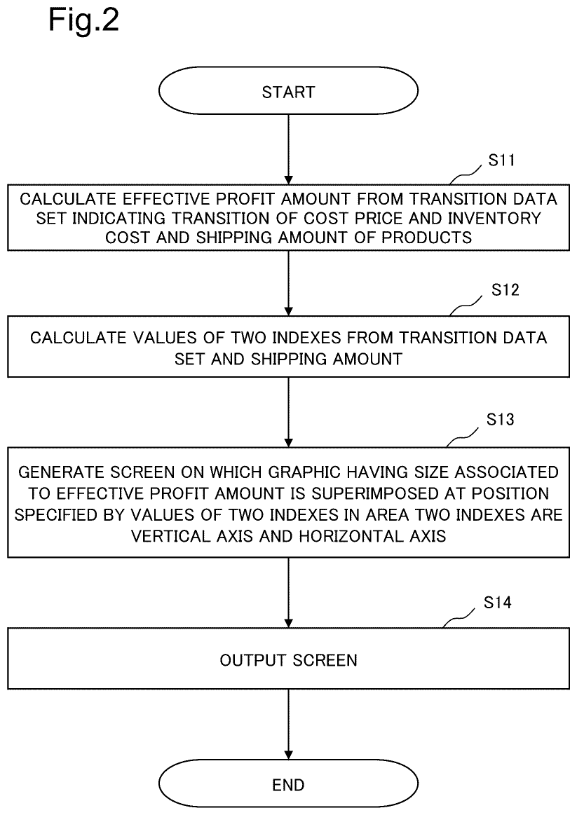

FIG. 2 is a flowchart illustrating an example of the operation of the visualization device according to the first example embodiment of the present disclosure. In the example illustrated in FIG. 2, first, the effective profit calculation unit 120 calculates an effective profit amount from a transition data set indicating transition of the cost price and the inventory cost and the shipping amount of products (step S11). Next, the index value calculation unit 130 calculates the values of the two indexes from the transition data set and the shipping amount (step S12).

Next, the screen generation unit 140 generates a screen on which a graphic having a size associated to the effective profit amount is superimposed at a position specified by the values of the two indexes in the area where the two indexes are the vertical axis and the horizontal axis (step S13). Then, the output unit 150 outputs the screen.

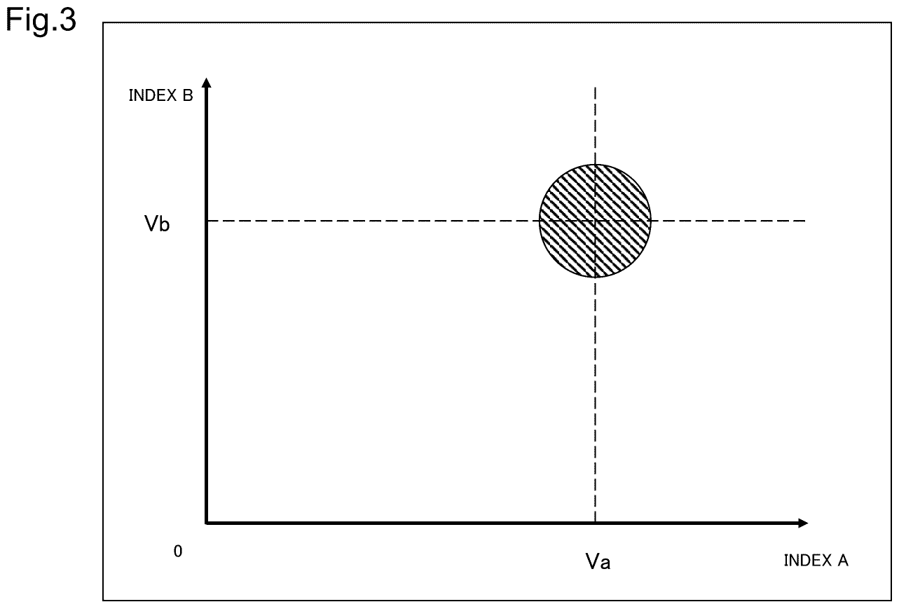

FIG. 3 is a diagram schematically illustrating an example of a screen output by the visualization device according to the first example embodiment of the present disclosure. In the example of FIG. 3, the two indexes are an index A and an index B. The value of the index A is Va. The value of the index B is Vb. A hatched circle is a graphic having a size associated to the amount of the effective profit amount. In the example illustrated in FIG. 3, an area in a case where both the value of the index A and the value of the index B are 0 or more is drawn. However, the screen may include an area including the position indicated by the negative value of the index whose value may be negative.

### Effects

The present example embodiment described above has an effect of being capable of visualizing the value of the index in consideration of the influence of the cost due to the transition of the inventory between the beginning of the term and the end of the term. This index is, for example, an effective profit amount.

This is because the effective profit calculation unit 120 calculates the effective profit amount representing the amount of profit obtained by subtracting the sum of the cost price and the sum of the inventory cost from the sales of the products in a period of a predetermined length from the target data set and the shipping amount of products. This is because the index value calculation unit 130 calculates, from the target data set and the shipping amount, values of two different indexes related to the transition of the inventory in the period. Further, this is because the screen generation unit 140 generates a screen on which a graphic having a size associated to the effective profit amount is superimposed at a position specified by the values of the two indexes in the area where one of the two indexes is the vertical axis and the other is the horizontal axis. As a result, an effective profit amount, which is the value of the index in which the influence of the cost due to the transition of the inventory between the beginning of the term and the end of the term is taken into consideration, is visualized.

In general, as the inventory quantity of products appearing in the financial index, an average value of the inventory quantity at the beginning of the period and the inventory quantity at the end of the period in which the financial index is calculated is used. The cost caused by the inventory between the beginning of the term and the end of the term varies depending on a difference in the transition of the inventory quantity, but the profit amount considering the cost caused by the inventory is not necessarily clear. According to the present example embodiment, the magnitude of the effective profit amount can be intuitively grasped by a graphic associated to the magnitude of the effective profit amount, which is the profit amount in consideration of the cost caused by the inventory. Furthermore, the graphic is superimposed on the position specified by the values of the two indexes related to the inventory transition, in such a way that it is also possible to simultaneously and intuitively grasp the effective profit amount and the values of the two indexes related to the inventory transition.

### First Modification of First Example Embodiment

Next, a first modification of the first example embodiment of the present disclosure will be described. The present modification is the same as the first example embodiment except for differences described below.

In the present modification, the target data set further includes a transition of the inventory quantity of products (specifically, data indicating a transition of the inventory quantity of products).

The screen generation unit 140 generates a screen further including a graph indicating the transition of the inventory quantity of the target data set. The area of the graph is, for example, an area that does not overlap with an area in which one of the two indexes on which the graphic is superimposed is a vertical axis and the other is a horizontal axis. For example, the screen generation unit 140 generates a graph (specifically, an image of the graph), and superimposes the generated graph (specifically, an image of the generated graph) on an area of the screen that does not overlap an area where one of the two indexes has a vertical axis and the other has a horizontal axis.

For example, in the operation of step S13 of FIG. 2, the screen generation unit 140 generates a screen further including a graph indicating the transition of the inventory quantity of the target data set.

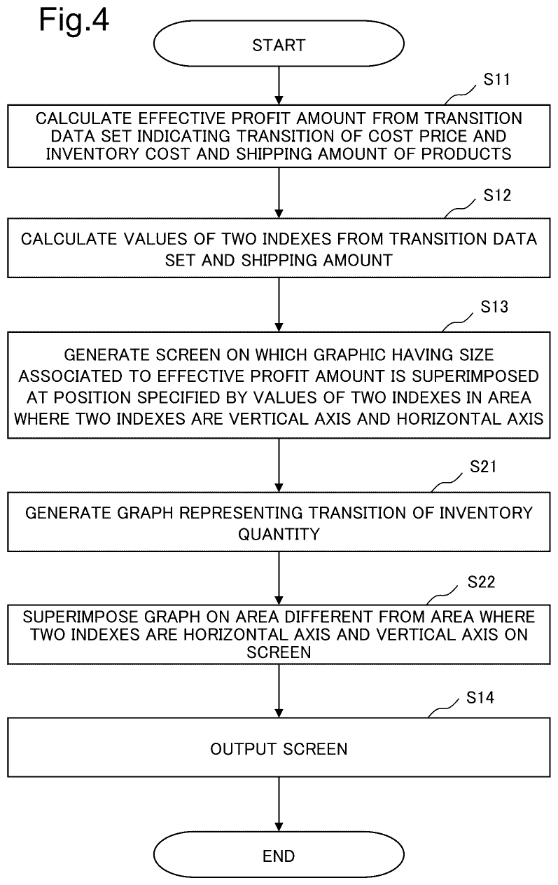

FIG. 4 is a flowchart illustrating an example of the operation of a visualization device 10 according to the first modification of the first example embodiment of the present disclosure. In the example illustrated in FIG. 4, the operations of step S11, step S12, and step S13 are the same as the operations of step S11, step S12, and step S13 illustrated in FIG. 2 of the visualization device 10 according to the first example embodiment.

In the example illustrated in FIG. 4, after the operation of step S13, the screen generation unit 140 generates a graph indicating the transition of the inventory quantity (step S21). Then, the screen generation unit 140 superimposes the graph on an area different from the area where the two indexes are the horizontal axis and the vertical axis on the screen (step S22).

In the example illustrated in FIG. 4, in step S22, the screen generation unit 140 superimposes a graph on the screen generated in step S13. The screen generation unit 140 may generate a screen on which a graph is superimposed in step S22, execute step S13 after step S22, and superimpose a graphic on the screen on which the graph is superimposed in step S13.

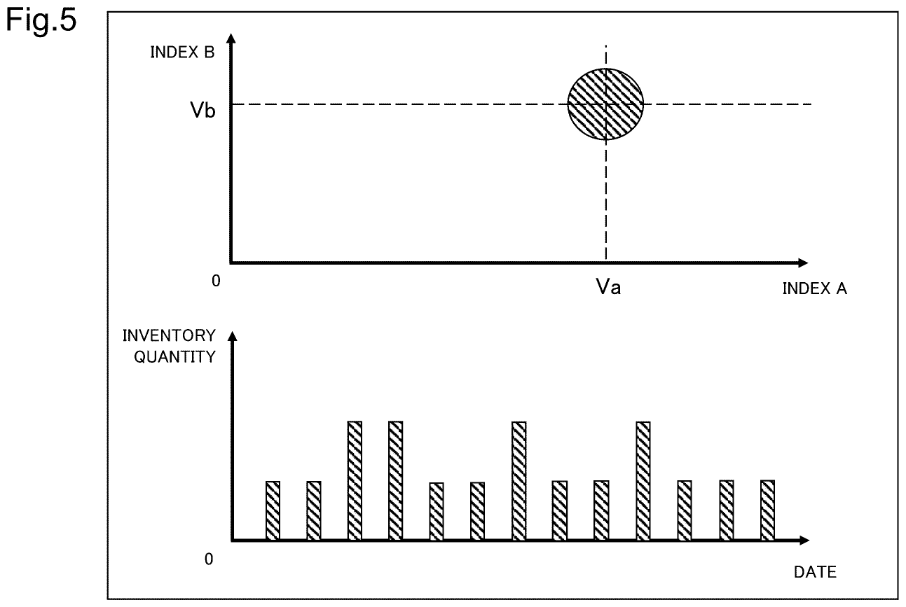

FIG. 5 is a diagram schematically illustrating an example of a screen output by a visualization device according to a first modification of the first example embodiment of the present disclosure.

In the example illustrated in FIG. 5, an area in which a graphic representing the effective profit amount is superimposed exists at an upper part of the screen, and a graph representing the transition of the inventory quantity exists at a lower part of the screen. However, a positional relationship between the area on which the graphic is superimposed and the graph is not limited to this example. For example, the graph may exist on an area on which the graphic is superimposed.

The graph may exist to the right of the area on which the graphic is superimposed. The graph may exist on the left of the area on which the graphic is superimposed. However, the positional relationship between the area on which the graphic is superimposed and the graph may be a positional relationship other than the above example.

The screen generation unit 140 may create a screen on which one of the graphic and the graph is superimposed, and generate a screen on which the graphic and the graph are superimposed, instead of superimposing the other of the graphic and the graph on the created screen.

In step S14, the output unit 150 outputs a screen including the above-described area on which the graphic is superimposed and the above-described area on which the graph is superimposed.

### Examples of Two Indexes

The two indexes described above are, for example, two of the effective profit rate described above, the inventory turnover rate described above, the production spike occurrence rate, and the shipping spike occurrence rate. The index value calculation unit 130 may calculate values of two indexes designated in advance from these indexes. The index value calculation unit 130 may calculate values of two indexes designated by the user from these indexes. An example in which the two indexes are designated by the user will be described later.

In a case where the effective profit rate is included in the two indexes, the index value calculation unit 130 calculates a value obtained by dividing the calculated effective profit amount by the shipping amount (that is, sales of products) of products as the effective profit rate. The effective profit rate is related to the effective profit amount. The effective profit amount is related to the transition of the inventory cost. The transition of the inventory cost is related to the transition of the inventory quantity. Therefore, the effective profit rate is related to the transition of inventory quantity.

In a case where the inventory turnover rate is included in the two indexes, the index value calculation unit 130 calculates, as the inventory turnover rate, a value obtained by dividing the shipment quantity of products in the above-described period by the total (that is, the cumulative value) of the inventory quantity of products in each unit period in the above-described period.

The production spike occurrence rate is a value obtained by dividing the number of times the production volume of products in the unit period becomes equal to or more than a predetermined value in the above-described period by the number of unit periods included in the above-described period. In a case where the two indexes include the production spike occurrence rate, the transition data set includes data of the transition of the production volume of products. The index value calculation unit 130 counts the number of times the production volume of products in the unit period has become equal to or more than a predetermined value in the data on the transition of the production volume of products included in the transition data set. Then, the index value calculation unit 130 calculates, as the production spike occurrence rate, a value obtained by dividing the number of times the production volume of products in the unit period becomes equal to or more than a predetermined value by the number of unit periods included in the above-described period. The production spike occurrence rate is related to the transition of the production volume. Among the produced products, the products that have not been shipped are in inventory. Therefore, the transition of the production volume of products is related to the transition of the inventory quantity of products.

The shipping spike occurrence rate is a value obtained by dividing the number of times the shipment quantity of products in the unit period becomes equal to or more than a predetermined value in the above-described period by the number of unit periods included in the above-described period. In a case where the two indexes include a shipping spike occurrence rate, the transition data set includes data for transitions in the shipment quantity of products. The index value calculation unit 130 counts the number of times the shipment quantity of products in the unit period has reached equal to or more than a predetermined value in the data on the transition of the shipment quantity of products included in the transition data set. Then, the index value calculation unit 130 calculates, as the shipping spike occurrence rate, a value obtained by dividing the number of times the shipment quantity of products in the unit period becomes equal to or more than a predetermined value by the number of unit periods included in the above-described period. The shipping spike occurrence rate is related to the transition of the shipment quantity. The shipment of the product reduces the inventory quantity of products. Therefore, the transition of the shipment quantity of products is related to the transition of the inventory quantity of products.

The predetermined value in the shipping spike occurrence rate may be different from the predetermined value in the production spike occurrence rate. The predetermined value in the shipping spike occurrence rate may be the same as the predetermined value in the production spike occurrence rate.

### Second Example Embodiment

Next, a second example embodiment of the present disclosure will be described in detail with reference to the drawings.

### Configuration

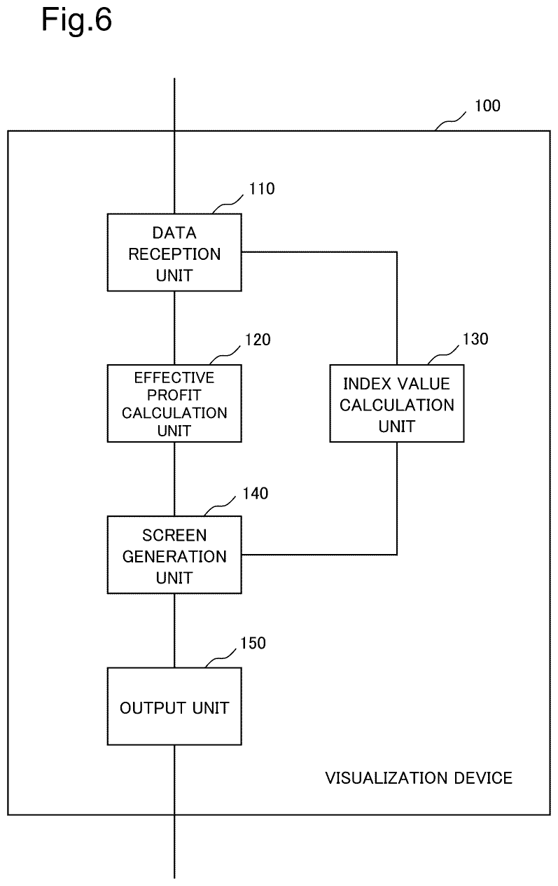

FIG. 6 is a block diagram illustrating an example of a configuration of a visualization device 100 according to a second example embodiment of the present disclosure. In the example illustrated in FIG. 6, the visualization device 100 includes a data reception unit 110, an effective profit calculation unit 120, an index value calculation unit 130, a screen generation unit 140, and an output unit 150. The effective profit calculation unit 120, the index value calculation unit 130, the screen generation unit 140, and the output unit 150 of the present example embodiment have the same functions as the effective profit calculation unit 120, the index value calculation unit 130, the screen generation unit 140, and the output unit 150 of the first example embodiment, respectively. Hereinafter, differences between the present example embodiment and the first example embodiment will be mainly described.

### Data Reception Unit 110

The data reception unit 110 receives input data including a target data set that is a transition data set and a comparison data set that is a transition data set different from the target data set. The number of target data sets received by the data reception unit 110 may be one. The data reception unit 110 may receive two or more target data sets.

The transition data set includes data included in the transition data set of the first example embodiment. In the present example embodiment, the transition data set further includes data of transition of the inventory quantity of products for each unit period shorter than the period of the predetermined length in the period. In other words, the target data set includes data of the transition of the inventory quantity of products in a period in which the data of the transition of the inventory cost and the data of the transition of the cost price included in the target data set represent the transition of the inventory cost and the transition of the cost price, respectively. The comparison data set includes data of a transition of the inventory quantity of products in a period in which the data of a transition of the inventory cost and the data of a transition of the cost price included in the comparison data set represent a transition of the inventory cost and a transition of the cost price cost, respectively. A period in which the data of the transition of the inventory cost and the data of the transition of the cost price included in the target data set represent the transition of the inventory cost and the transition of the cost price, respectively, is also referred to as a period of the target data set and a target period below. A period in which the data of the transition of the inventory cost and the data of the transition of the cost price included in the comparison data set indicate the transition of the inventory cost and the transition of the cost price, respectively, is also referred to as a period of the comparison data set and a comparison period.

The data reception unit 110 further receives a shipping amount (specifically, data of the shipping amount of products) of the above-described products in the period of the target data set and a shipping amount of products in the period of the comparison data set. As described above, the shipping amount of products is the total sales of the products in the above-described period. Hereinafter, the shipping amount of products in the period of the target data set is also referred to as a target shipping amount. The shipping amount of products in the period of the comparison data set is also referred to as a comparison shipping amount. The data of the shipping amount of products (that is, the data of the target shipping amount and the data of the comparative shipping amount) may be included in the input data. The target shipping amount and the comparative shipping amount may be different. The target shipping amount and the comparative shipping amount may be the same.

All of the target data set and the comparison data set may be a transition data set representing transitions between actual inventory costs and cost prices for different periods of the same length. At least one of the target data set and the comparison data set may be a transition data set representing transitions between simulated inventory costs and cost prices. All of the target data set and the comparison data set may be a transition data set representing transitions between simulated inventory costs and cost prices.

### Effective Profit Calculation Unit 120

Similarly to the effective profit calculation unit 120 of the first example embodiment, the effective profit calculation unit 120 calculates the effective profit amount representing the amount of profit obtained by subtracting the sum of the cost price and the sum of the inventory cost from the sales of the products in a period of a predetermined length from the target data set and the shipping amount of products. Hereinafter, the effective profit amount calculated from the target data set is referred to as a target effective profit amount.

The effective profit calculation unit 120 further calculates an effective profit amount representing the amount of profit obtained by subtracting the sum of the cost prices and the sum of the inventory costs from the sales of the product in a period of a predetermined length from the comparison data set and the shipping amount of products.

Hereinafter, the effective profit amount calculated from the comparison data set is referred to as a comparative effective profit amount. In a case where two or more comparison data sets are received, the effective profit calculation unit 120 calculates a comparative effective profit amount from each of the two or more comparison data sets.

### Index Value Calculation Unit 130

Similarly to the index value calculation unit 130 of the first example embodiment, the index value calculation unit 130 calculates, from the target data set and the above-described shipping amount (that is, the shipping amount of products), values of two different indexes related to the inventory transition in the period. Hereinafter, the value of the index calculated from the target data set is referred to as a target index value.

The index value calculation unit 130 further calculates, from the comparison data set and the above-described shipping amount (that is, the shipping amount of products), values of two different indexes related to the inventory transition in the period. Hereinafter, the value of the index calculated from the comparison data set is referred to as a comparison index value. In a case where two or more comparison data sets are received, the index value calculation unit 130 calculates comparison index values of two indexes from each of the two or more comparison data sets.

In the following description, the two indexes are, for example, an inventory turnover rate and an effective profit rate. As described above, the two indexes are not limited to these examples. In a case where any of the two indexes is an index other than the inventory turnover rate and the effective profit rate of the two index examples described above, the input data includes the data described in the description of the two index examples.

As described above, the input data includes the information on the sales amount associated to the target data set and the information on the sales amount associated to the comparison data set. The sales amount associated to the target data set is the sales amount of products in the period of the above-described predetermined length in a situation where the transition of the inventory cost and the transition of the cost price are represented by the data included in the target data set. The sales amount associated to the comparison data set is the sales amount of products in the period of the above-described predetermined length in a situation where the transition of the inventory cost and the transition of the cost price are represented by the data included in the comparison data set.

As described above, the effective profit rate is a value obtained by dividing the effective profit amount by the sales amount. The index value calculation unit 130 calculates a value obtained by dividing the effective profit amount in the period of the predetermined length by the sales amount of products in the period of the predetermined length as the effective profit rate. The sales amount of products is the shipping amount of products described above. The index value calculation unit 130 sets a value obtained by dividing the target effective profit amount by the sales amount of products as a target index value of an index which is an effective profit rate. The index value calculation unit 130 sets a value obtained by dividing the comparative effective profit amount by the sales amount of products as a comparison index value of an index which is an effective profit rate.

For example, as described below, the index value calculation unit 130 calculates, as the value of the inventory turnover rate, a value obtained by dividing the shipment quantity in the period of the predetermined length by the cumulative value of the inventory quantity of products for each unit period in the period.

The transition data set (that is, each of the target data set and the comparison data set) further includes data of a transition of the inventory quantity of products per unit period in a period of a predetermined length. In other words, the target data set includes data of transition of the inventory cost of the products, the cost price of the products, and the inventory quantity of products for each unit period in a period of a predetermined length. Similarly, the comparison data set includes data of transitions between the inventory cost of the products, the cost price of the products, and the inventory quantity of products for each unit period in a period of a predetermined length.

The index value calculation unit 130 calculates a total of the inventory quantity in the transition of the inventory quantity of products included in the transition data set as a cumulative value of the inventory quantity. Specifically, the index value calculation unit 130 calculates the total inventory quantity in the transition of the inventory quantity of products included in the target data set as the cumulative value of the inventory quantity in the period of the target data set. The index value calculation unit 130 calculates the total inventory quantity in the transition of the inventory quantity of products included in the comparison data set as the cumulative value of the inventory quantity in the period of the comparison data set.

The input data may include the shipment quantity of the product during a period of the target data set and the shipment quantity of the product during a period of a comparison data set. For example, in a case where the product is one type of product and the price of one product does not change, the index value calculation unit 130 may hold the price of one product in advance. The input data may include a price for one product. In this case, the index value calculation unit 130 calculates a value obtained by dividing the shipping amount of products in the period of the target data set by the price of one product as the shipment quantity of products in the period of the target data set. The index value calculation unit 130 calculates a value obtained by dividing the shipping amount of products in the period of the comparison data set by a price of one product as the shipment quantity of products in the period of the comparison data set.

The transition data set may further include a transition of the shipment quantity of products per unit period in the period of the predetermined length described above. In this case, the index value calculation unit 130 calculates the total number of shipment quantity in the period of the predetermined length as the shipment quantity of the product from the transition of the shipment quantity of the product in each unit period in the period of the predetermined length. Specifically, the index value calculation unit 130 calculates the total number of the shipment quantity of the product in the transition of the shipment quantity of the product included in the target data set as the shipment quantity of the product in the period of the target data set. The index value calculation unit 130 calculates the total of the shipment quantity of the product in the transition of the shipment quantity of the product included in the comparison data set as the shipment quantity of the product in the period of the comparison data set.

Then, the index value calculation unit 130 calculates, as the value of the inventory turnover rate, a value obtained by dividing the shipment quantity of products in the period of the predetermined length obtained in this manner by the cumulative value in the period of the inventory quantity of products for each unit period in the period. Specifically, the index value calculation unit 130 calculates a value obtained by dividing the shipment quantity of products in the period of the target data set by the cumulative value of the inventory quantity of products in the period of the target data set as the value of the inventory turnover rate in the period of the target data set. The index value calculation unit 130 calculates a value obtained by dividing the shipment quantity of products in the period of the comparison data set by the cumulative value of the inventory quantity of products in the period of the comparison data set as the value of the inventory turnover rate in the period of the comparison data set.

### Screen Generation Unit 140

The screen generation unit 140 generates a screen in which a graphic having a size associated to the comparative effective profit amount is further superimposed on a position specified by the comparison index value in addition to a graphic having a size associated to the target effective profit amount being superimposed on a position specified by the target index value in the above-described area. In other words, the screen generation unit 140 generates a screen in which a graphic having a size associated to the target effective profit amount is superimposed on the position specified by the target index value in the above-described area, and a graphic having a size associated to the comparative effective profit amount is superimposed on the position specified by the comparison index value. The above-described area is an area in which one of the two indexes is on the vertical axis and the other is on the horizontal axis. In a case where two or more comparison data sets are received, the screen generation unit 140 generates a screen in which a graphic having a size associated to the comparative effective profit amount is further superimposed on a position specified by the calculated comparison index value of each of the two or more comparison data sets.

The screen generation unit 140 may generate a screen such that a form of a graphic having a size associated to the target effective profit amount and a form of a graphic having a size associated to the comparative effective profit amount are different from each other. In this case, for example, the type of the contour, which is at least one of the color and pattern of the graphic and the type and color of the contour of the graphic, is, for example, the type of the contour line (solid line, broken line, one-dot chain line, and the like).

### Output Unit 150

The output unit 150 outputs the screen generated by the screen generation unit 140. Specifically, the output unit 150 outputs the screen generated by the screen generation unit 140 to, for example, at least one of the display device of the visualization device 100 and another device (for example, a terminal device, a server device, a storage device, and the like) communicably connected to the visualization device 100.

### Operation

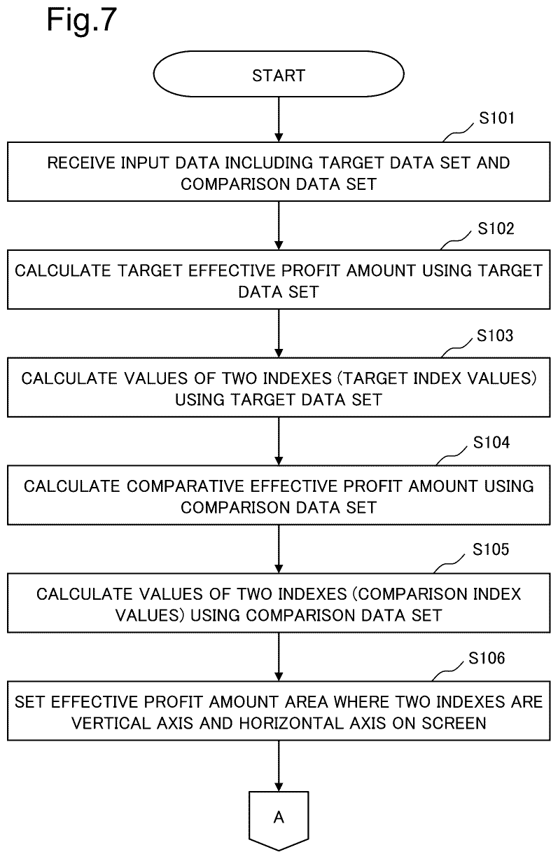

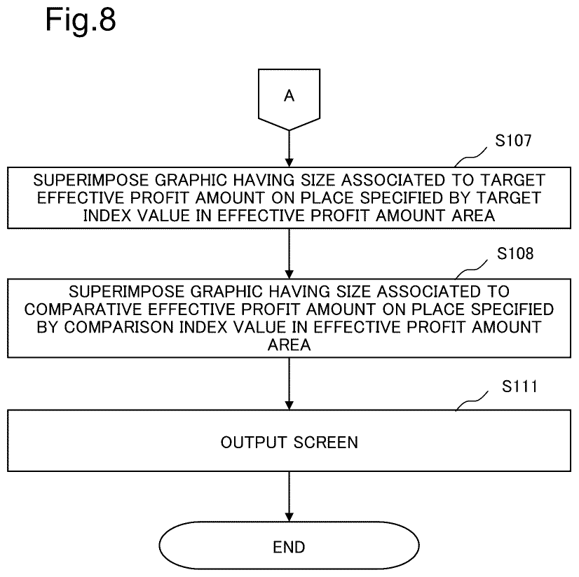

FIGS. 7 and 8 are flowcharts illustrating an example of the operation of the visualization device according to the second example embodiment of the present disclosure. The visualization device 100 of the present example embodiment performs the operation illustrated in FIG. 8 following the operation illustrated in FIG. 7.

In the examples illustrated in FIGS. 7 and 8, first, the data reception unit 110 receives input data including a target data set and a comparison data set (step S101).

The effective profit calculation unit 120 calculates the target effective profit amount using the target data set (step S102). In other words, the effective profit calculation unit 120 calculates the target effective profit amount from the target data set and the shipping amount of products. The index value calculation unit 130 calculates two index values (that is, the target index value) using the target data set (step S103). The index value calculation unit 130 may use the shipping amount of products to calculate the target index value.

The effective profit calculation unit 120 calculates a comparative effective profit amount using the comparison data set (step S104). In other words, the effective profit calculation unit 120 calculates the comparative effective profit amount from the comparison data set and the shipping amount of products. The index value calculation unit 130 calculates the values of the two indexes (that is, the comparison index value) using the comparison data set (step S105). The index value calculation unit 130 may use the shipping amount of products to calculate the comparison index value.

Next, the screen generation unit 140 sets an effective profit amount area in which the two indexes are the vertical axis and the horizontal axis on the screen (step S106). The effective profit amount area may be determined in advance on the screen.

The screen generation unit 140 superimposes a graphic having a size associated to the target effective profit amount on a place specified by the target index value in the effective profit amount area (step S107). The screen generation unit 140 superimposes a graphic having a size associated to the comparative effective profit amount on a place specified by the comparison index value in the effective profit amount area (step S108).

Then, the output unit 150 outputs the generated screen (step S111).

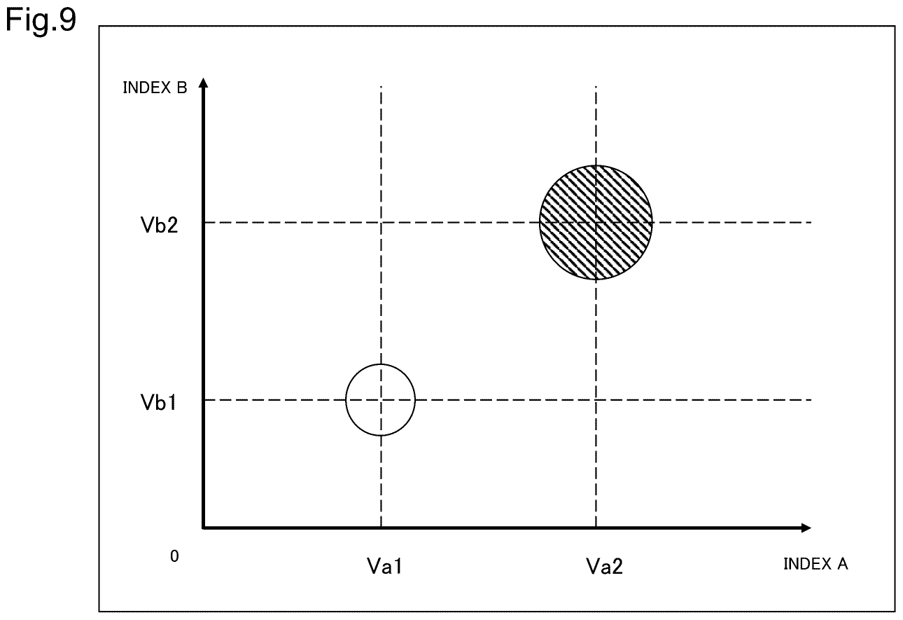

FIG. 9 is a diagram schematically illustrating an example of a screen output by the visualization device according to the second example embodiment of the present disclosure. In the example illustrated in FIG. 9, the two indexes are an index A and an index B. The value of the index A calculated using the target data set is Va2. The value of the index B calculated using the target data set is Vb2. The value of the index A calculated using the comparison data set is Va1. The value of the index B calculated using the comparison data set is Vb1. A graphic having a size associated to the target effective profit amount calculated from the target data set is a hatched circle. A graphic having a size associated to the target effective profit amount calculated from the comparison data set is a white circle (that is, an unhatched circle).

### Effects

The present example embodiment has the effect same as that of the first example embodiment. The reason is the same as the reason why the effect of the first example embodiment occurs.

The present example embodiment further has an effect of being capable of visualizing the difference between the two index values and the difference between the effective profit amounts due to the difference in the transition of the inventory quantity. This is because the effective profit calculation unit 120 calculates the target effective profit amount using the target data set and calculates the comparison effective profit rate using the comparison data set. This is because the index value calculation unit 130 calculates the target index values of the two indexes using the target data set and calculates the comparison index values of the two indexes using the comparison data set. Further, this is because the screen generation unit 140 superimposes a graphic having a size associated to the comparison effective profit rate on a place specified by the target index values of the two indexes on the screen, and superimposes a graphic having a size associated to the comparison effective profit rate on a place specified by the comparison index values of the two indexes.

### First Modification of Second Example Embodiment

Hereinafter, a first modification of the second example embodiment of the present disclosure will be described.

### Configuration

The visualization device 100 according to the present modification is the same as the visualization device 100 of the second example embodiment except for differences described below.

The screen generation unit 140 generates a screen further including a graph indicating the transition of the inventory quantity of the target data set and the transition of the inventory quantity of the comparison data set. The area of the graph is, for example, an area that does not overlap with an area in which one of the two indexes on which the graphic is superimposed is a vertical axis and the other is a horizontal axis. For example, the screen generation unit 140 generates a graph (specifically, an image of the graph), and superimposes the generated graph (specifically, an image of the generated graph) on an area of the screen that does not overlap an area where one of the two indexes has a vertical axis and the other has a horizontal axis.

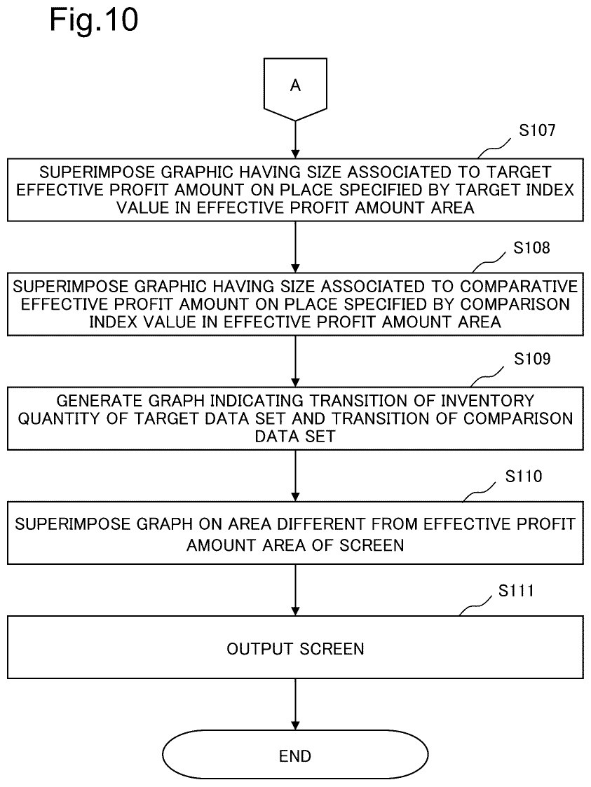

FIGS. 7 and 10 are flowcharts illustrating an example of the operation of the visualization device 100 according to the first modification of the second example embodiment of the present disclosure. The visualization device 100 of the present modification performs the operation illustrated in FIG. 10 following the operation illustrated in FIG. 7. The operation illustrated in FIG. 7 of the visualization device 100 of the present modification is the same as the operation illustrated in FIG. 7 of the visualization device 100 of the second example embodiment.

The operation illustrated in FIG. 10 is similar to the operation illustrated in FIG. 8 except that the operations in steps S109 and S110 are performed after step S108.

In step S109, the screen generation unit 140 generates a graph indicating the transition of the inventory quantity of the target data set and the transition of the inventory quantity of the comparison data set.

In step S110, the screen generation unit 140 superimposes the graph on an area different from the effective profit amount area of the screen.

In step S111, the output unit 150 outputs the screen generated in step S110.

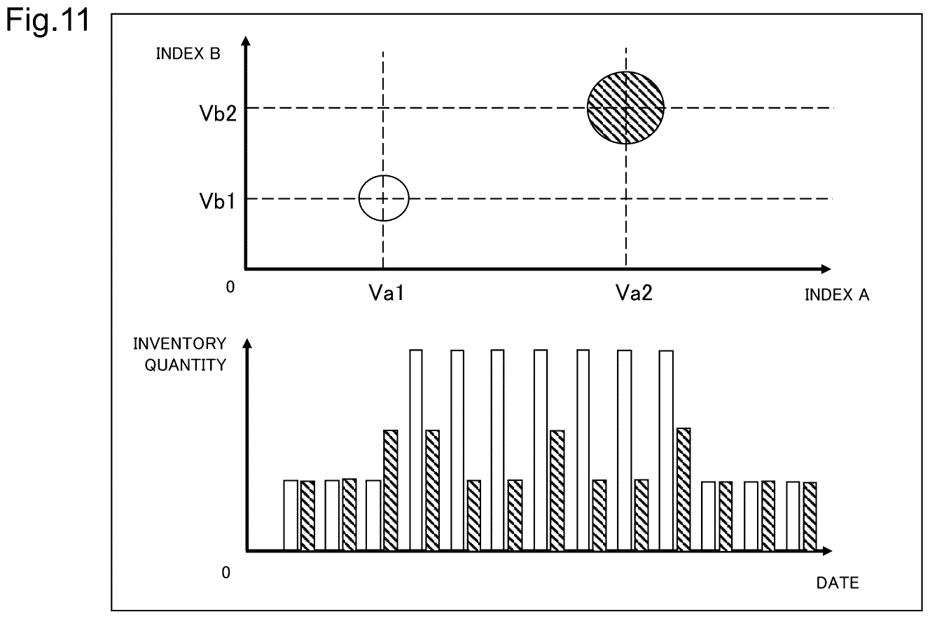

FIG. 11 is a diagram schematically illustrating an example of a screen output by the visualization device 100 according to the first modification of the second example embodiment of the present disclosure. Similarly to the example illustrated in FIG. 9, in the example illustrated in FIG. 11, the two indexes are an index A and an index B. The value of the index A calculated using the target data set is Va2. The value of the index B calculated using the target data set is Vb2. The value of the index A calculated using the comparison data set is Va1. The value of the index B calculated using the comparison data set is Vb1. A graphic having a size associated to the target effective profit amount calculated from the target data set is a hatched circle. A graphic having a size associated to the target effective profit amount calculated from the comparison data set is a white circle (that is, an unhatched circle).

The graph on the lower side of FIG. 11 is a graph illustrating the transition of the inventory quantity of products. In the example illustrated in FIG. 11, the hatched bar graph represents the transition of the inventory quantity of products of the target data set. A non-hatched bar chart (that is, a white bar graph) represents the transition of the inventory quantity for the comparison data set. As in this example, the screen generation unit 140 may generate one graph representing the transition of the inventory quantity in two or more data sets (that is, the target data set and the one or more comparison data sets). Unlike this example, the screen generation unit 140 may generate two or more different graphs that respectively represent inventory quantity transitions in two or more data sets. In this case, screen generation unit 140 superimposes the generated two or more graphs on the screen.

The present modification can also be applied to other modifications.

### Second Modification of Second Example Embodiment

Hereinafter, a second modification of the second example embodiment of the present disclosure will be described.

### Configuration

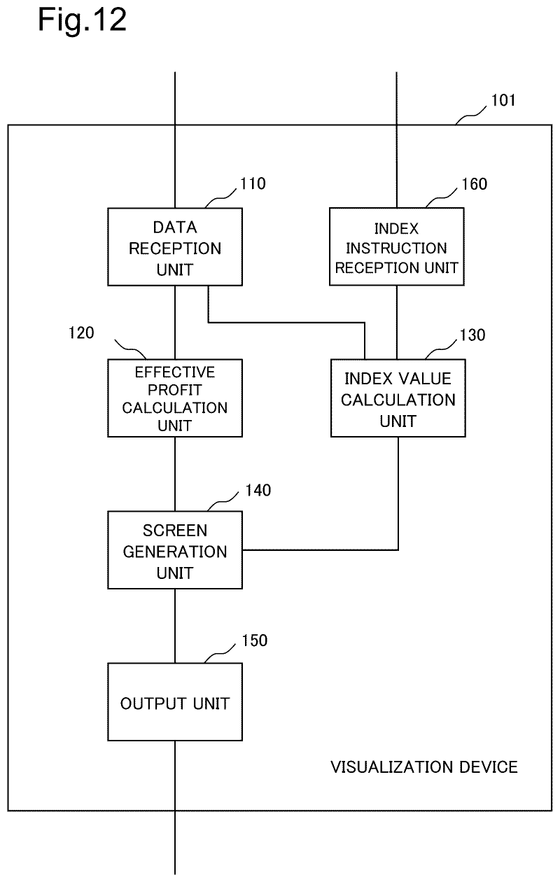

FIG. 12 is a block diagram illustrating an example of a configuration of a visualization device according to a second modification of the second example embodiment of the present disclosure. A visualization device 101 of the present disclosure further includes an index instruction reception unit 160 in addition to the data reception unit 110, the effective profit calculation unit 120, the index value calculation unit 130, the screen generation unit 140, and the output unit 150. The data reception unit 110, the effective profit calculation unit 120, the index value calculation unit 130, the screen generation unit 140, and the output unit 150 of the present example embodiment are the same as the data reception unit 110, the effective profit calculation unit 120, the index value calculation unit 130, the screen generation unit 140, and the output unit 150 of the second example embodiment, respectively, except for differences described below.

### Data Reception Unit 110

The data reception unit 110 receives input data including a target data set that is a transition data set and a comparison data set that is a transition data set different from the target data set. In the present modification, the transition data set includes data indicating transition of the inventory cost of the product, the cost price of the product, the production volume of products, the shipment quantity of the product, and the inventory quantity of the product for each unit period shorter than a period of a predetermined length in the period.

### Index Instruction Reception Unit 160

The index instruction reception unit 160 receives an index instruction designating two indexes from, for example, an input device of the visualization device 101 or a user terminal communicably connected to the visualization device 101. The index instruction reception unit 160 displays a screen of a user interface for selecting an index on the display device of the visualization device 101, for example. Then, the index instruction reception unit 160 receives information on the selected two indexes input via an input device such as a keyboard, a mouse, or a touch panel of the visualization device 101. The index instruction reception unit 160 causes, for example, the user terminal to display a screen of a user interface for selecting an index. Then, the index instruction reception unit 160 receives information on the selected two indexes input via an input device such as a keyboard, a mouse, or a touch panel of the user terminal.

The user interface to be displayed by the index instruction reception unit 160 may be, for example, a user interface that allows selection from an effective profit rate, an inventory turnover rate, a production spike occurrence rate, and a shipping spike occurrence rate. The index instruction reception unit 160 may receive information on two indexes selected from an effective profit rate, an inventory turnover rate, a production spike occurrence rate, and a shipping spike occurrence rate.

### Index Value Calculation Unit 130

The index value calculation unit 130 calculates the values (specifically, the target index value and the comparison index value) of the two indexes indicated by the information on the selected two indexes received by the index instruction reception unit 160.

### Operation

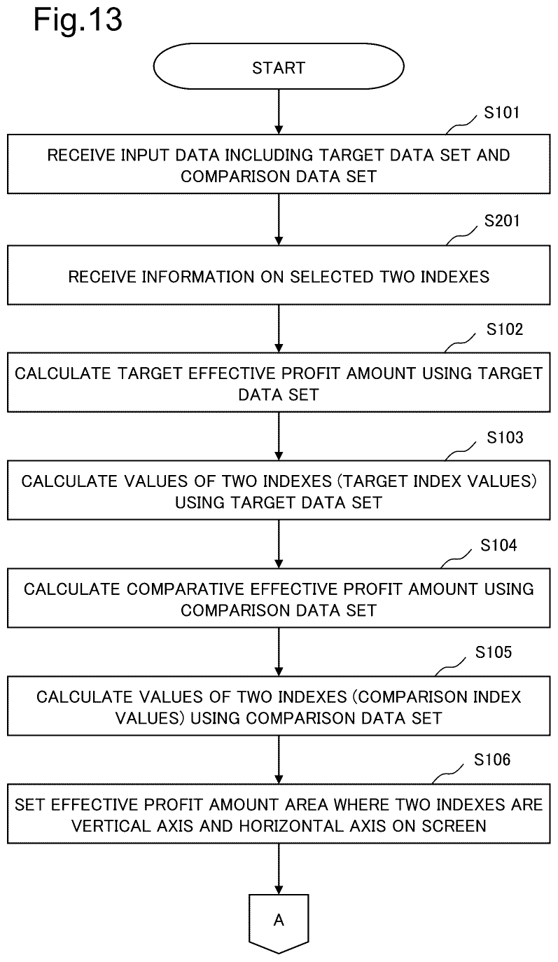

FIGS. 13 and 8 are flowcharts illustrating an example of the operation of the visualization device 101 according to the second modification of the second example embodiment of the present disclosure. The visualization device 101 performs the operation illustrated in FIG. 8 following the operation illustrated in FIG. 13. The operation illustrated in FIG. 13 of the visualization device 101 of the present modification is the same as the operation illustrated in FIG. 7 of the visualization device 100 of the second example embodiment except for differences described below. The operation illustrated in FIG. 8 of the visualization device 101 of the present modification is the same as the operation illustrated in FIG. 8 of the visualization device 100 of the second example embodiment.

The visualization device 101 of the present modification performs the operation of step S201 after the operation of step S101.

In step S201, the index instruction reception unit 160 receives information on the selected two indexes.

In step S103, the index value calculation unit 130 calculates the values (that is, the target index values) of the two indexes indicated by the information on the selected two indexes. In step S105, the index value calculation unit 130 calculates the values (that is, the comparison index values) of the two indexes indicated by the information on the selected two indexes.

The present modification can also be applied to other modifications of the second example embodiment.

### Third Modification of Second Example Embodiment

Hereinafter, a third modification of the second example embodiment of the present disclosure will be described.

### Configuration

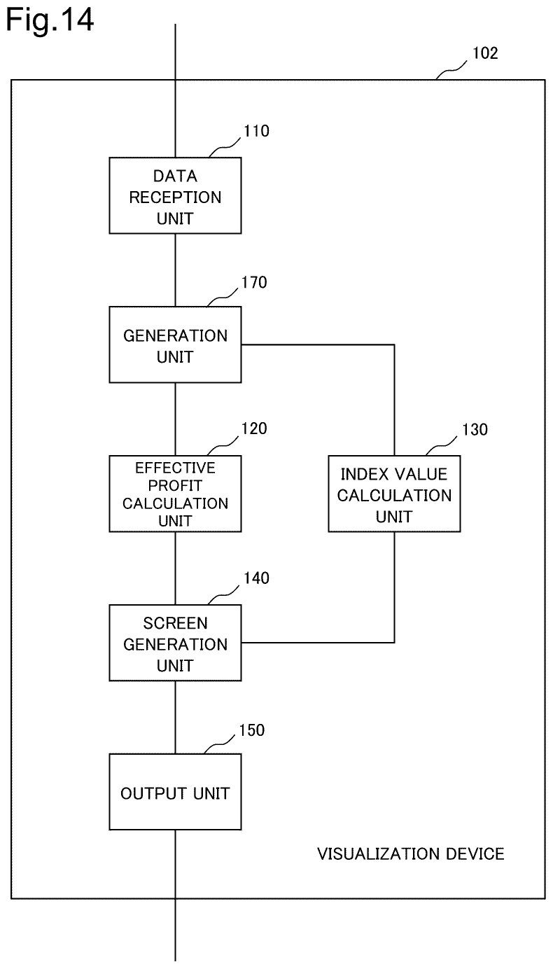

FIG. 14 is a block diagram illustrating an example of a configuration of a visualization device 102 according to a third modification of the second example embodiment of the present disclosure. In the example illustrated in FIG. 14, the visualization device 102 of the present modification further includes a generation unit 170 in addition to the data reception unit 110, the effective profit calculation unit 120, the index value calculation unit 130, the screen generation unit 140, and the output unit 150. The data reception unit 110, the effective profit calculation unit 120, the index value calculation unit 130, the screen generation unit 140, and the output unit 150 of the present example embodiment are the same as the data reception unit 110, the effective profit calculation unit 120, the index value calculation unit 130, the screen generation unit 140, and the output unit 150 of the second example embodiment, respectively, except for differences described below.

### Data Reception Unit 110

In the present modification, the data reception unit 110 receives input data including either the transition data set or the plan data. Specifically, the input data includes target plan data that is a target data set or plan data that is a transition data set, and comparison plan data that is a comparison data set or plan data that is a transition data set. The plan data will be described in detail later.

The plan data includes, for example, an inventory quantity of products at the beginning of a period of a predetermined length, shipping plan data, production plan data, cost data, and a shipping amount of one product. The shipping plan data (in other words, the shipping schedule) includes data of a time in which a product is shipped and the shipment quantity of products at the time in a period of a predetermined length. The production plan data (in other words, the schedule of production) includes data of a time in which a product is produced and the number of products produced at the time in a period of a predetermined length.

The cost data includes inventory cost data and cost price data in a period of a predetermined length. The inventory cost data included in the cost data includes an inventory cost of one product and an inventory cost that does not depend on the number of products. The data of the cost price included in the cost data is a cost price of one product. In a case where at least one of the inventory cost of one product and the inventory cost that does not depend on the number of products fluctuates in the period of the predetermined length, the inventory cost data included in the cost data includes data of transition between the inventory cost of one product for each unit period in the period of the predetermined length and the inventory cost that does not depend on the number of products.

In a case where the cost price of one product varies in the period of the predetermined length, the data of the cost price included in the cost data includes data of transition of the cost price of one product for each unit period in the period of the predetermined length. The cost price data may include a cost of a part used for a product, a cost of an alternative part usable for the product, and information on a part used for production of one product and an alternative part for each time in the period of the above-described predetermined length.

### Generation Unit 170

The generation unit 170 generates a transition data set from the plan data (that is, the inventory quantity of products at the beginning of the period of the predetermined length, the shipping plan data, the production plan data, the cost data, and the shipping amount of one product). The generation unit 170 further calculates the shipment quantity of products and the shipping amount in a period of a predetermined length from the plan data.

Specifically, in a case where the target plan data is included in the input data, the generation unit 170 generates the target data set from the target plan data, and calculates the shipment quantity and the shipping amount of products in the period of the target data set from the target plan data. In a case where the input data includes the comparison plan data, the generation unit 170 generates the target data set from the comparison plan data, and calculates the shipment quantity and the shipping amount of products in the period of the comparison data set from the comparison plan data.

Specifically, the generation unit 170 generates a transition data set from the plan data as follows, and calculates the shipment quantity and the shipping amount of products in a period of a predetermined length.

The generation unit 170 generates a transition of the shipment quantity of products per unit period in a period of a predetermined length by using the shipping plan data. Using the shipping plan data, the generation unit 170 calculates the shipment quantity of products in the period of the predetermined length. The generation unit 170 calculates the shipping amount of products in the period of the predetermined length from the shipment quantity of products and the shipping amount of one product.

Using the production plan data, the generation unit 170 generates a transition of the production volume of products per unit period in a period of a predetermined length. Using the inventory quantity of products at the beginning of the period of the predetermined length, the transition of the shipment quantity of products, and the transition of the production volume, the generation unit 170 calculates the transition of the inventory quantity of products for each unit period in the period of the predetermined length. The generation unit 170 calculates the transition of the inventory cost of the products for each unit period in a period of a predetermined length by using the calculated transition of the inventory quantity and the inventory cost data of the cost data. Using the transition of the generated production volume and the data of the cost price of the cost data, the generation unit 170 calculates the transition of the cost price of the products for each unit period in a period of a predetermined length.

As described above, the cost price data may include a cost of a part used in a product, a cost of an alternative part usable in the product, and information on a part used in production of one product and an alternative part for each time in the period of the predetermined length described above. In this case, the generation unit 170 may calculate data of transition of the cost price per unit period in the period described above from the production plan data, the cost of the part used for the product, the cost of the substitute part usable for the product, and the information on the part used for production of one product and the substitute part for each time.

### Operation

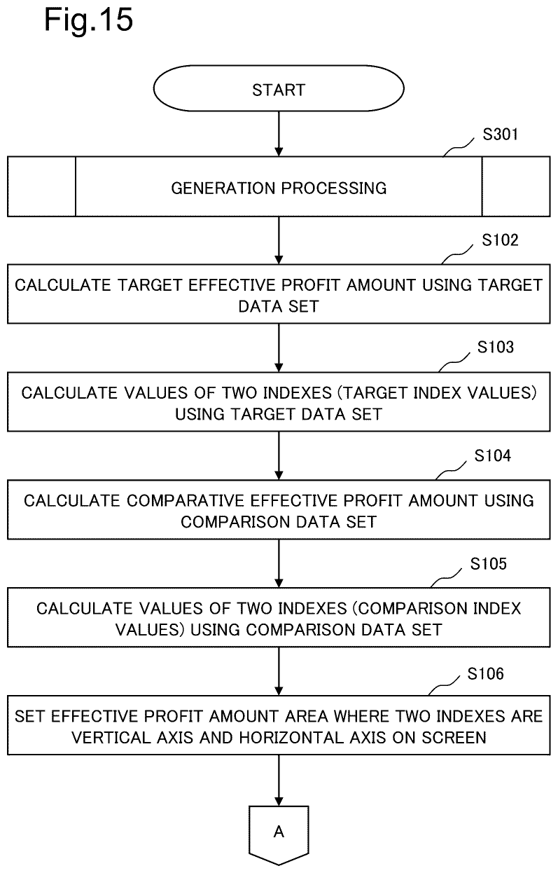

FIGS. 15 and 8 are flowcharts illustrating an example of the operation of the visualization device 102 according to the third modification of the second example embodiment of the present disclosure. The visualization device 102 of the present modification performs the operation illustrated in FIG. 8 after the operation illustrated in FIG. 15. The operation illustrated in FIG. 15 of the visualization device 102 of the present modification is the same as the operation illustrated in FIG. 7 of the visualization device 100 of the second example embodiment except for differences described below. The operation illustrated in FIG. 8 of the visualization device 102 of the present modification is the same as the operation illustrated in FIG. 8 of the visualization device 100 of 8 the second example embodiment.

In the example illustrated in FIG. 15, the visualization device 102 of the present modification performs the operation of step S301 instead of step S101. In step S301, the visualization device 102 performs generation processing. The operations of steps after step S102 of the visualization device 102 of the modification are the same as the operations of steps after step S102 illustrated in FIG. 7 of the visualization device 100 of the second example embodiment.

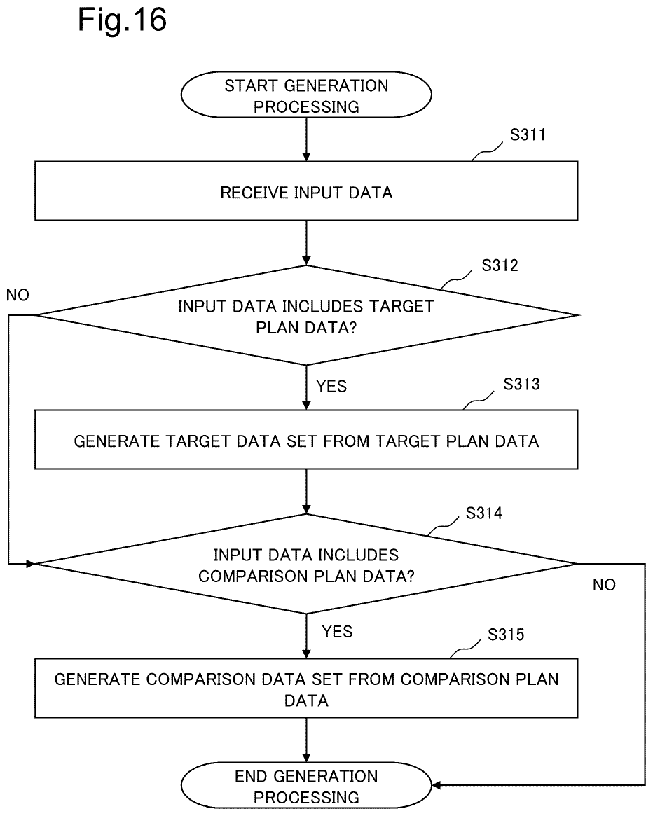

FIG. 16 is a flowchart illustrating an example of the operation of the generation processing of the visualization device 102 according to the third modification of the second example embodiment of the present disclosure.

In the example illustrated in FIG. 16, first, the data reception unit 110 receives input data (step S311). Next, the generation unit 170 determines whether the input data includes target plan data (step S312). In a case where the input data does not include the target plan data (NO in step S312), the visualization device 102 then performs the operation of step S314.

In a case where the input data includes the target plan data (YES in step S312), the generation unit 170 generates a target data set from the target plan data (step S313). Then, the visualization device 102 then performs the operation of step S314.

In step S314, the generation unit 170 determines whether the input data includes the comparison plan data. In a case where the input data does not include the comparison plan data (NO in step S314), the visualization device 102 ends the operation illustrated in FIG. 16.

In a case where the input data includes the comparison plan data (YES in step S314), the generation unit 170 generates a comparison data set from the comparison plan data (step S315). Then, the visualization device 102 ends the operation illustrated in FIG. 16.

The input data of the present modification may include one or more target data sets and one or more target plan data. The input data of the present modification may include two or more pieces of target plan data. In this case, the generation unit 170 generates the target data set from each of the target plan data included in the input data. The effective profit calculation unit 120 calculates an effective profit amount for each of the target data sets. The index value calculation unit 130 calculates a target index value for each target data set. The screen generation unit 140 superimposes a graphic having a size associated to the effective profit amount on a position specified by the target index value on the screen for each target data set.

The present modification can also be applied to other modifications of the second example embodiment.

The input data of the present modification may not include the comparison data set as the transition data set and the comparison plan data as the plan data. In that case, the generation unit 170 does not generate the comparison data set. The effective profit calculation unit 120 does not calculate the comparative effective profit amount. The index value calculation unit 130 does not calculate the comparison index value.

Then, the screen generation unit 140 does not superimpose a graphic having a size associated to a comparative profit amount on the screen.

In this case, the present modification can be applied to the first example embodiment and the first modification of the first example embodiment.

### Fourth Modification of Second Example Embodiment

Next, a fourth modification of the second example embodiment of the present disclosure will be described. The configuration of the visualization device 102 according to the present modification is the same as the configuration of the visualization device 102 according to the third modification of the second example embodiment of the present disclosure. The visualization device 102 according to the present modification is the same as the visualization device 102 according to the third modification of the second example embodiment of the present disclosure except for differences described below.

The input data of the present modification receives target plan data not including production plan data.

The generation unit 170 of the present modification generates the production plan data using the shipping plan data of the target plan data, the cost data, and the shipping amount of one product by, for example, a technique such as multivariate analysis or another optimization technique. The generation unit 170 generates a target data set from the shipping plan data of the target plan data, the cost data, the shipping amount of one product, and the generated production plan data.

### Other Example Embodiments

The visualization device (that is, the visualization device 10, the visualization device 100, the visualization device 101, and the visualization device 102) according to any one of the above-described example embodiments and modifications can be achieved by a computer including a memory in which a program read from a storage medium is loaded and a processor that executes the program. The visualization device according to any one of the above-described example embodiments and modifications can also be achieved by dedicated hardware. The visualization device according to any one of the above-described example embodiments and modifications can also be achieved by a combination of the above-described computer and dedicated hardware.

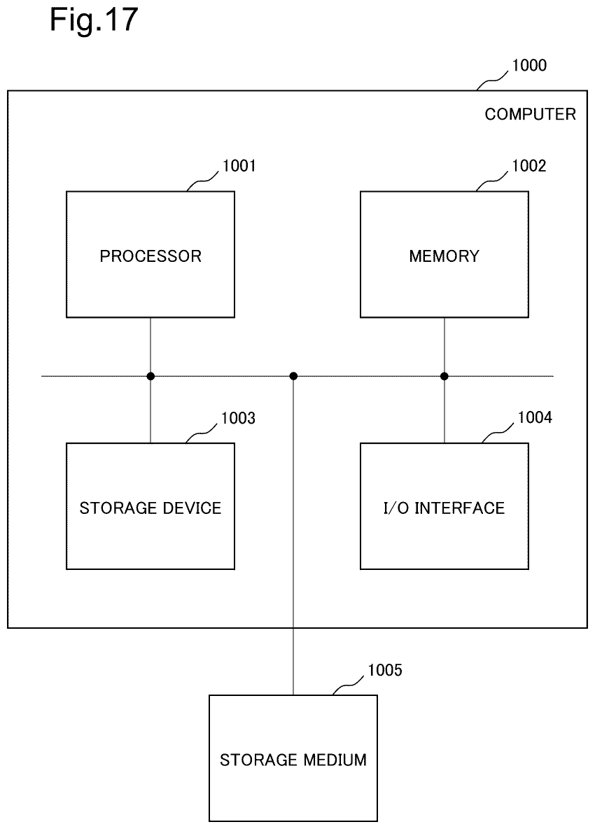

FIG. 17 is a diagram illustrating an example of a hardware configuration of a computer 1000 that can implement the visualization device according to any one of the example embodiment and the modifications of the present disclosure. In the example illustrated in FIG. 17, the computer 1000 includes a processor 1001, a memory 1002, a storage device 1003, and an input/output (I/O) interface 1004. The computer 1000 can access a storage medium 1005. The memory 1002 and the storage device 1003 are, for example, storage devices such as a random access memory (RAM) and a hard disk. The storage medium 1005 is, for example, a storage device such as a RAM or a hard disk, a read only memory (ROM), or a portable storage medium. The storage device 1003 may be the storage medium 1005. The processor 1001 can read and write data and programs from and in the memory 1002 and the storage device 1003. The processor 1001 can access, for example, other devices via the I/O interface 1004. The processor 1001 may access the storage medium 1005. The storage medium 1005 stores a program for causing the computer 1000 to operate as the visualization device according to any one of the example embodiment and the modification of the present disclosure.

The processor 1001 loads a program, which is stored in the storage medium 1005 and causes the computer 1000 to operate as the visualization device according to any one of the example embodiment and the modification of the present disclosure, into the memory 1002. Then, the processor 1001 executes the program loaded in the memory 1002, and then the computer 1000 operates as the visualization device according to any one of the example embodiment and the modification of the present disclosure.

The data reception unit 110, the effective profit calculation unit 120, the index value calculation unit 130, the screen generation unit 140, the output unit 150, the index instruction reception unit 160, and the generation unit 170 can be achieved by, for example, the processor 1001 that executes a program loaded in the memory 1002. Some or all of the data reception unit 110, the effective profit calculation unit 120, the index value calculation unit 130, the screen generation unit 140, the output unit 150, the index instruction reception unit 160, and the generation unit 170 can be achieved by a dedicated circuit that achieves the functions of the respective units.

Some or all of the above example embodiments may be denoted as the following Supplementary Notes, but are not limited to the following.

### Supplementary Note 1

A visualization device including:
effective profit amount calculation means for calculating an effective profit amount representing an amount of profit obtained by subtracting a sum of cost prices and a sum of inventory costs from sales of products in a predetermined length period from a target data set that is a transition data set including data indicating transition of the inventory cost due to the inventory of the products and the cost prices of the produced products for each unit period shorter than a period of a predetermined length in the period and a shipping amount of products;
index value calculation means for calculating, by using at least one of the target data set, the shipping amount, and a transition of the inventory quantity of products for each unit period in the period, values of two different indexes related to the transition of the inventory quantity in the period;
screen generation means for generating a screen on which a graphic having a size associated to the effective profit amount is superimposed at a position specified by values of the two indexes in an area in which one of the two indexes is a vertical axis and the other is a horizontal axis; and output means for outputting the screen.

### Supplementary Note 2

The visualization device according to Supplementary Note 1, in which
the effective profit amount calculation means calculates the effective profit amount of each of one or more comparison data sets from each of the one or more comparison data sets that are the transition data set different from the target data set and the shipping amount,
the index value calculation means calculates values of the two indexes of each of the one or more comparison data sets from each of the one or more comparison data sets and the shipping amount, and
the screen generation means generates the screen in which a graphic having a size associated to the effective profit amount of each of the one or more comparison data sets is superimposed at a position specified by the values of the two indexes of each of the one or more comparison data sets in the area.

### Supplementary Note 3

The visualization device according to Supplementary Note 2, in which
the screen generation means superimposes the graphic of the target data set and the graphic of each of the one or more comparison data sets in different modes.

### Supplementary Note 4

The visualization device according to Supplementary Note 1, in which
the screen generation means generates the screen further including a graph indicating a transition of the inventory quantity of the target data set.

### Supplementary Note 5

The visualization device according to Supplementary Note 2, in which
the screen generation means generates the screen further including a graph indicating transition of the inventory quantity of the target data set and transition of the inventory quantity of each of the one or more comparison data sets.

### Supplementary Note 6

The visualization device according to Supplementary Note 1 or 2, in which
the transition data set includes a transition of the inventory quantity of products for each unit period in the period,
the two indexes include an inventory turnover rate, and
the index value calculation means calculates a value obtained by dividing the shipment quantity of products in the period by a cumulative value of the inventory quantity of products for each unit period in the period as a value of the inventory turnover rate.

### Supplementary Note 7

The visualization device according to Supplementary Note 1 or 2, in which
the target data set is the transition data set generated from target plan data that is plan data including a cost of a part used for the product or a cost of a substitute part for the part, and a production schedule of the products.

### Supplementary Note 8

The visualization device according to Supplementary Note 2, in which
the target data set is the transition data set generated from target plan data that is plan data including a cost of a part used for the product or a cost of a substitute part for the part, and a production schedule of the product, and
the one or more comparison data sets are the transition data sets generated from comparison plan data that is the plan data different from the target plan data.

### Supplementary Note 9

The visualization device according to Supplementary Note 7 ,further including
generation means for generating the transition data set from the target plan data.

### Supplementary Note 10

The visualization device according to Supplementary Note 8, further including
generation means for generating the transition data set from the plan data,
in which the generation means generates the transition data set from the target plan data and generates the one or more comparison data sets from the one or more comparison plan data.

### Supplementary Note 11

The visualization device according to Supplementary Note 2, in which
the target data set and the one or more comparison data sets are the transition data sets of the period at different times of the same length.

### Supplementary Note 12

The visualization device according to Supplementary Note 1 or 2, in which
the transition data set includes a transition of the shipment quantity of products and a transition of the production volume of the products for each unit period in the period, and
the index value calculation means calculates, as the two indexes, any two values selected from an effective profit rate which is a ratio of the effective profit amount to the sales of the products in the period, an inventory turnover rate, a production spike occurrence rate which is a value obtained by dividing the number of times the production volume of the products in the unit period becomes equal to or more than a predetermined value in the period by the number of the unit periods in the period, and a shipping spike occurrence rate which is a value obtained by dividing the number of times the shipment quantity of products in the unit period becomes equal to or more than a predetermined value in the period by the number of the unit periods in the period.

### Supplementary Note 13

A visualization method including:
calculating an effective profit amount representing an amount of profit obtained by subtracting a sum of cost prices and a sum of inventory costs from sales of products in a predetermined length period from a target data set that is a transition data set including data indicating transition of the inventory cost due to the inventory of the products and the cost prices of the produced products for each unit period shorter than a period of a predetermined length in the period and a shipping amount of products;
calculating, by using at least one of the target data set, the shipping amount, and a transition of the inventory quantity of products for each unit period in the period, values of two different indexes related to the transition of the inventory quantity in the period;
generating a screen on which a graphic having a size associated to the effective profit amount is superimposed at a position specified by values of the two indexes in an area in which one of the two indexes is a vertical axis and the other is a horizontal axis; and
outputting the screen.

### Supplementary Note 14

The visualization method according to Supplementary Note 13, further including
calculating the effective profit amount of each of one or more comparison data sets from each of the one or more comparison data sets that are the transition data set different from the target data set and the shipping amount,
calculating values of the two indexes of each of the one or more comparison data sets from each of the one or more comparison data sets and the shipping amount, and
generating the screen in which a graphic having a size associated to the effective profit amount of each of the one or more comparison data sets is superimposed at a position specified by the values of the two indexes of each of the one or more comparison data sets in the area.

### Supplementary Note 15

The visualization method according to Supplementary Note 14, further including
superimposing the graphic of the target data set and the graphic of each of the one or more comparison data sets in different modes.

### Supplementary Note 16

The visualization method according to Supplementary Note 13, further generating the screen further including a graph indicating a transition of the inventory quantity of the target data set.

### Supplementary Note 17

The visualization method according to Supplementary Note 14, further generating the screen further including a graph indicating transition of the inventory quantity of the target data set and transition of the inventory quantity of each of the one or more comparison data sets.

### Supplementary Note 18

The visualization method according to Supplementary Note 13 or 14, in which
the transition data set includes a transition of the inventory quantity of products for each unit period in the period,
the two indexes include an inventory turnover rate, and
the method further including calculating a value obtained by dividing the shipment quantity of products in the period by a cumulative value of the inventory quantity of products for each unit period in the period as a value of the inventory turnover rate.

### Supplementary Note 19

The visualization method according to Supplementary Note 13 or 14, in which
the target data set is the transition data set generated from target plan data that is plan data including a cost of a part used for the product or a cost of a substitute part for the part, and a production schedule of the products.

### Supplementary Note 20

The visualization method according to Supplementary Note 14, in which
the target data set is the transition data set generated from target plan data that is plan data including a cost of a part used for the product or a cost of a substitute part for the part, and a production schedule of the product, and
the one or more comparison data sets are the transition data sets generated from comparison plan data that is the plan data different from the target plan data.

### Supplementary Note 21

The visualization method according to Supplementary Note 19, further including
generating the transition data set from the target plan data.

### Supplementary Note 22

The visualization method according to Supplementary Note 20, further including
generating the transition data set from the plan data, and
generating the transition data set from the target plan data and generates the one or more comparison data sets from the one or more comparison plan data.

### Supplementary Note 23

The visualization method according to Supplementary Note 14, in which
the target data set and the one or more comparison data sets are the transition data sets of the period at different times of the same length.

### Supplementary Note 24

The visualization method according to Supplementary Note 13 or 14, in which
the transition data set includes a transition of the shipment quantity of products and a transition of the production volume of the products for each unit period in the period, and
the method further includes calculating, as the two indexes, any two values selected from an effective profit rate which is a ratio of the effective profit amount to the sales of the products in the period, an inventory turnover rate, a production spike occurrence rate which is a value obtained by dividing the number of times the production volume of the products in the unit period becomes equal to or more than a predetermined value in the period by the number of the unit periods in the period, and a shipping spike occurrence rate which is a value obtained by dividing the number of times the shipment quantity of products in the unit period becomes equal to or more than a predetermined value in the period by the number of the unit periods in the period.

### Supplementary Note 25

A program for causing a computer to execute:
effective profit amount calculation processing for calculating an effective profit amount representing an amount of profit obtained by subtracting a sum of cost prices and a sum of inventory costs from sales of products in a predetermined length period from a target data set that is a transition data set including data indicating transition of the inventory cost due to the inventory of the products and the cost prices of the produced products for each unit period shorter than a period of a predetermined length in the period and a shipping amount of products;
index value calculation processing for calculating, by using at least one of the target data set, the shipping amount, and a transition of the inventory quantity of products for each unit period in the period, values of two different indexes related to the transition of the inventory quantity in the period;
screen generation processing for generating a screen on which a graphic having a size associated to the effective profit amount is superimposed at a position specified by values of the two indexes in an area in which one of the two indexes is a vertical axis and the other is a horizontal axis; and
output processing for outputting the screen.

### Supplementary Note 26

The program according to Supplementary Note 25, in which
the effective profit amount calculation processing calculates the effective profit amount of each of one or more comparison data sets from each of the one or more comparison data sets that are the transition data set different from the target data set and the shipping amount,
the index value calculation processing calculates values of the two indexes of each of the one or more comparison data sets from each of the one or more comparison data sets and the shipping amount, and
the screen generation processing generates the screen in which a graphic having a size associated to the effective profit amount of each of the one or more comparison data sets is superimposed at a position specified by the values of the two indexes of each of the one or more comparison data sets in the area.

### Supplementary Note 27

The program according to Supplementary Note 26, in which
the screen generation processing superimposes the graphic of the target data set and the graphic of each of the one or more comparison data sets in different modes.

### Supplementary Note 28

The program according to Supplementary Note 25, in which
the screen generation processing generates the screen further including a graph indicating a transition of the inventory quantity of the target data set.

### Supplementary Note 29

The program according to Supplementary Note 26, in which
the screen generation processing generates the screen further including a graph indicating transition of the inventory quantity of the target data set and transition of the inventory quantity of each of the one or more comparison data sets.

### Supplementary Note 30

The program according to Supplementary Note 25 or 26, in which
the transition data set includes a transition of the inventory quantity of products for each unit period in the period,
the two indexes include an inventory turnover rate, and
the index value calculation processing calculates a value obtained by dividing the shipment quantity of products in the period by a cumulative value of the inventory quantity of products for each unit period in the period as a value of the inventory turnover rate.

### Supplementary Note 31

The program according to Supplementary Note 25 or 26, in which
the target data set is the transition data set generated from target plan data that is plan data including a cost of a part used for the product or a cost of a substitute part for the part, and a production schedule of the products.

### Supplementary Note 32

The program according to Supplementary Note 26, in which
the target data set is the transition data set generated from target plan data that is plan data including a cost of a part used for the product or a cost of a substitute part for the part, and a production schedule of the product, and
the one or more comparison data sets are the transition data sets generated from comparison plan data that is the plan data different from the target plan data.

### Supplementary Note 33

The program according to Supplementary Note 31, further causing the program to execute
generation processing for generating the transition data set from the target plan data.

### Supplementary Note 34

The program according to Supplementary Note 32, further causing the computer to execute
generation processing for generating the transition data set from the plan data,
in which the generation processing generates the transition data set from the target plan data and generates the one or more comparison data sets from the one or more comparison plan data.

### Supplementary Note 35

The program according to Supplementary Note 26, in which
the target data set and the one or more comparison data sets are the transition data sets of the period at different times of the same length.

### Supplementary Note 36

The program according to Supplementary Note 35 or 26, in which
the transition data set includes a transition of the shipment quantity of products and a transition of the production volume of the products for each unit period in the period, and
the index value calculation processing calculates, as the two indexes, any two values selected from an effective profit rate which is a ratio of the effective profit amount to the sales of the products in the period, an inventory turnover rate, a production spike occurrence rate which is a value obtained by dividing the number of times the production volume of the products in the unit period becomes equal to or more than a predetermined value in the period by the number of the unit periods in the period, and a shipping spike occurrence rate which is a value obtained by dividing the number of times the shipment quantity of products in the unit period becomes equal to or more than a predetermined value in the period by the number of the unit periods in the period.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

### REFERENCE SIGNS LIST

10 visualization device
100 visualization device
101 visualization device
102 visualization device
110 data reception unit
120 effective profit calculation unit
130 index value calculation unit
140 screen generation unit
150 output unit
160 index instruction reception unit
170 generation unit
1000 computer
1001 processor
1002 memory
1003 storage device
1004 I/O interface
1005 storage medium

What is claimed is:

1. A visualization device comprising:
one or more memories storing instructions; and
one or more processors configured to execute the instructions to:
calculate an effective profit amount from a target data set and a shipping amount of products, the target data set being a transition data set including data indicating transition of an inventory cost due to the inventory of products and cost prices of produced products for each unit period shorter than a predetermined length period, the effective profit amount representing an amount of profit obtained by subtracting a sum of the cost prices and a sum of inventory costs from sales of products in the predetermined length period;
calculate, by using at least one of the target data set, the shipping amount, and a transition of the inventory quantity of products for each unit period in the period, values of two different indexes related to the transition of the inventory quantity in the period;
generate a screen on which a graphic having a size associated to the effective profit amount is superimposed at a position specified by values of the two indexes in an area in which one of the two indexes is a vertical axis and the other is a horizontal axis; and
output the screen.

2. The visualization device according to claim 1, wherein
the one or more processors are configured to execute the instructions to:
calculate the effective profit amount of each of one or more comparison data sets from each of the one or more comparison data sets that are the transition data set different from the target data set and the shipping amount,
calculate values of the two indexes of each of the one or more comparison data sets from each of the one or more comparison data sets and the shipping amount, and
generate the screen in which a graphic having a size associated to the effective profit amount of each of the one or more comparison data sets is superimposed at a position specified by the values of the two indexes of each of the one or more comparison data sets in the area.

3. The visualization device according to claim 2, wherein
the one or more processors are configured to execute the instructions to superimpose the graphic of the target data set and the graphic of each of the one or more comparison data sets in different modes.

4. The visualization device according to claim 1, wherein the one or more processors are configured to execute the instructions to generate the screen further including a graph indicating a transition of the inventory quantity of the target data set.

5. The visualization device according to claim 2, wherein
the one or more processors are configured to execute the instructions to generate the screen further including a graph indicating transition of the inventory quantity of the target data set and transition of the inventory quantity of each of the one or more comparison data sets.

6. The visualization device according to claim 1, wherein
the transition data set includes a transition of the inventory quantity of products for each unit period in the period,
the two indexes include an inventory turnover rate, and
the one or more processors are configured to execute the instructions to calculate a value obtained by dividing the shipment quantity of products in the period by a cumulative value of the inventory quantity of products for each unit period in the period as a value of the inventory turnover rate.

7. The visualization device according to claim 1, wherein
the target data set is the transition data set generated from target plan data that is plan data including a cost of a part used for the product or a cost of a substitute part for the part, and a production schedule of the products.

8. The visualization device according to claim 2, wherein
the target data set is the transition data set generated from target plan data that is plan data including a cost of a part used for the product or a cost of a substitute part for the part, and a production schedule of the product, and
the one or more comparison data sets are the transition data sets generated from comparison plan data that is the plan data different from the target plan data.

9. A visualization method comprising:
by a computer,
calculating an effective profit amount from a target data ser and a shipping amount of products, the target data set being a transition data set including data indicating transition of an inventory cost due to the inventory of products and cost prices of produced products for each unit period shorter than a predetermined length period, the effective profit amount representing an amount of profit obtained by subtracting a sum of the cost prices and a sum of inventory costs from sales of products in the predetermined length period;
calculating, by using at least one of the target data set, the shipping amount, and a transition of the inventory quantity of products for each unit period in the period, values of two different indexes related to the transition of the inventory quantity in the period;
generating a screen on which a graphic having a size associated to the effective profit amount is superimposed at a position specified by values of the two indexes in an area in which one of the two indexes is a vertical axis and the other is a horizontal axis; and
outputting the screen.

10. A non-transitory storage medium storing a program for causing a computer to execute:
calculating an effective profit amount from a target data set and a shipping amount of products, the target data set being a transition data set including data indicating transition of an inventory cost due to the inventory of products and cost prices of produced products for each unit period shorter than a predetermined length period, the effective profit amount representing an amount of profit obtained by subtracting a sum of the cost prices and a sum of inventory costs from sales of products in the predetermined length period;
calculating, by using at least one of the target data set, the shipping amount, and a transition of the inventory quantity of products for each unit period in the period, values of two different indexes related to the transition of the inventory quantity in the period;
generating a screen on which a graphic having a size associated to the effective profit amount is superimposed at a position specified by values of the two indexes in an area in which one of the two indexes is a vertical axis and the other is a horizontal axis; and
outputting the screen.
